(19) United States
(12) Patent Application Publication
(10) Pub. No.: US 2017/0028812 A1
(43) Pub. Date: Feb. 2, 2017

(54) SPEED ENHANCEMENT FOR HVAC MODE KINEMATICS

(71) Applicant: Hanon Systems, Daejeon (KR)

(72) Inventors: Ralph Wiesmann, Euskirchen (DE); Martin Paul Nowak, Rosrath (DE); Antonio Alberto Marques Ferreira, Konigswinter (DE); Detlef Handwerk, Koln (DE)

(21) Appl. No.: 15/223,042

(22) Filed: Jul. 29, 2016

(30) Foreign Application Priority Data
Jul. 29, 2015 (DE) 102015112378.9

(51) Int. Cl. B60H 1/00; B60S 1/02

(52) U.S. Cl. CPC B60H 1/00842; B60S 1/023; B60H 1/00678; B60H 2001/00707

(57) ABSTRACT

A system and method for air distribution in an air conditioning system of a motor vehicle, the system including flow paths with air outlets toward the windshield, in the dashboard, and toward the footwell, along with a central gear mechanism having an adjustment element and damper controls for air dampers, for the purpose of opening and closing the air outlets. The adjustment element is arranged to be steplessly movable between a first end position and a second end position. With the system, in particular by moving the adjustment element, the settings “windshield damper open”, “footwell damper open” and “dashboard damper open” may be selected. The central gear mechanism having the adjustment element and the damper controls is configured such that the “windshield damper open” setting may be selected at either of the end positions of the adjustment element.

### CROSS-REFERENCE TO RELATED PATENT APPLICATION

This patent application claims priority to German Patent Application No. DE 102015112378.9 filed on Jul. 29, 2015, the disclosure of which is incorporated herein by reference in its entirety.

### FIELD OF THE INVENTION

The invention relates to a system and method for air distribution in an air conditioning system of a motor vehicle. The system comprises flow paths with air outlets toward the windshield, in the dashboard and toward the footwell, and a central gear mechanism having an adjustment element and damper controls for air dampers designed for opening and closing the air outlets. The adjustment element can be moved steplessly between two end positions, allowing the system to be adjusted to the air distribution settings “windshield damper open”, “footwell damper open” and “dashboard damper open”.

### BACKGROUND OF THE INVENTION

Conditioning the air within the passenger compartment of a motor vehicle, in addition to providing a pleasant and comfortable climate for the vehicle passengers, also ensures clear visibility through the windows, particularly through the windshield. Ventilating the windshield also prevents fogging.

In most prior art air distribution systems for vehicle air conditioning systems, the conditioned air flow mass is distributed via three different types of dampers. The dampers are used for opening and closing outlet openings which are provided at the end of flow paths for the air. As the air flows out through the outlet openings, also called air outlets, it is conducted toward the windshield or windscreen, out of the dashboard toward the vehicle passengers, and into the footwell.

The dampers are coupled to one another via a central gear mechanism or a central drive. The central gear mechanism is understood as a central adjustment element, which in most cases moves a plurality of dampers using a cam disk with integrated cam tracks and damper controls, particularly in the form of levers.

Disclosed in DE 10 2005 056 017 A1 is a combined air blending and air distribution actuating unit for manual heating and air conditioning systems for motor vehicles, having a first actuator for opening up a blended air flow path and a second actuator for opening up an air distribution flow path. The two actuators are connected to one another by means of a coupling element. For controlling the air blending and air distribution actuating unit, an actuating element is provided, which engages either with one of the two actuators or with the coupling element. Using the single actuating element, the blended air flow path and the air distribution flow path can be opened up and/or closed at the same time. The coupling element is embodied as a central gear mechanism or gate-type gear mechanism with a pivotable guide disk, also called a cam disk, having at least two tracks. The first actuator engages with the first track and the second actuator engages with the second track of the cam disk.

With the systems known from the prior art, a movement of the central gear mechanism, in particular a rotation of the cam disk, changes the positioning of the damper controls and thus the positioning of the dampers. In most cases, rotation of the cam disk effects the following sequence of positions of the dampers, and thus the following sequence of air distribution settings, in which each of the individual air distribution settings is passed through one time.
a) the “windshield damper open” setting, in which the conditioned air flow mass is conducted only toward the windshield, and toward side windows as desired and as permitted by design,
b) the “windshield and footwell damper open” setting, in which the conditioned air flow mass flows toward the windshield, and toward side windows as desired and as permitted by design, and through the air outlets into the footwell,
c) the “footwell damper open” setting, in which the air flows only through the air outlets into the footwell,
d) the “all dampers open” setting, in which the air is distributed and conducted through all air outlets,
e) the “dashboard and footwell dampers open” setting, in which the conditioned air flow mass flows through the air outlets in the dashboard and into the footwell, the “dashboard damper open” setting, in which the air is conducted into the passenger compartment only through the air outlets in the dashboard, and
g) the “dashboard and windshield dampers open” setting, in which the conditioned air flow mass flows out through the air outlets in the dashboard and toward the windshield or toward side windows.

The “windshield and footwell dampers open”, “all dampers open”, “dashboard and footwell dampers open” and “dashboard and windshield dampers open” settings are blended settings. This sequence of settings and number of settings are provided by way of example.

The aforementioned sequence of positions of the dampers and thus the sequence of air distribution settings is illustrated in FIG. 1 by way of a graph illustrating the valve adjustment in a traditional air distribution system. In the graph, the angles of the dampers for the air outlets toward the windshield, in the dashboard and into the footwell are plotted using separate characteristic curves, as a function of the angle of the cam disk to be adjusted.

The cam disk can be rotated, for example using a control knob located on the dashboard of the motor vehicle, within an angle range of 0° to 230°. However, the air distribution may also be adjusted using buttons, or by means of an automatic mechanism on the control unit. With a purely mechanical transmission of the air distribution setting from the control unit to the air conditioning unit, for example by means of a shaft or a Bowden cable, the desired setting is transmitted directly and without delay. With an electrical transmission of the air distribution setting via an electrical connection to an electrical servo motor for adjusting the cam disk, a time delay occurs between the selection of the desired setting via the control unit and the actual adjustment of the air conditioning unit due to the rotating speed of the servo motor, based on its technical specifications.

To decrease the time delay experienced with electrical transmission before the “windshield damper open” setting is reached, the damper can be adjusted using an additional servo motor. In this case, the dampers to the air outlets in the dashboard and to the footwell are optionally coupled to one another via a central drive and an additional servo motor. However, additional servo motors result in added technical complexity and costs, in terms of both the air conditioning system and the operating unit.

In general, if a damper is at an angle of around 0°, the air outlet associated with that damper is closed. The greater the angle of the position of the damper, the wider the opening of the flow cross-section of the air outlet or the flow path. The air outlets assigned to the angles of the cam disk each represent regions in which the specified air outlets are substantially open.

For example, when the cam disk is at an angle of around 0°, and in a blended setting with the flow path toward the air outlets in the dashboard, at an angle of around 230°, the flow path toward the air outlets in the direction of the windshield is open.

For the operation of the air conditioning system, target values for maximum adjustment times for the air dampers are defined. Specifically, the time required to reach the only “windshield damper open” setting must enable the driver of the vehicle to rapidly defog the windshield.

With the traditional sequence of positions of the dampers and thus the sequence of air distribution settings, the “windshield damper open” setting is reached when the cam disk is at an angle of only 0°, and thus at the initial position. The “windshield damper open” setting is otherwise possible only in a blended setting with the “dashboard and windshield dampers open” setting, when the cam disk is at an angle of 230°, and thus at the end of the adjustment path sequence of the cam disk. However, the “dashboard damper open” setting may not necessarily be desired.

In the least favorable case of the “dashboard and windshield dampers open” setting, when the cam disk is at an angle of somewhat less than 230°, it is necessary to sweep through the entire adjustment path of the cam disk, or through the angle range from 230° to 0°, in order to reach the “windshield damper open” setting. Sweeping through an angle range of 230° takes approximately 9.6 seconds, assuming an adjustment rate of 24°/second.

Moreover, when sweeping through the entire angle range of the cam disk, the system passes through air distribution settings such as “dashboard damper open” and footwell damper open”, which may be unexpected, undesirable or even unpleasant to the operator or the driver of the motor vehicle.

KR 2008 0100904 A discloses an system for air distribution in an air conditioning system of a motor vehicle having a damper control apparatus, with which the most frequently used air distribution settings of “windshield damper open” and “dashboard damper open” can be selected quickly and are located adjacent to one another on a control element for the driver of the motor vehicle. The system thus passes through the “windshield damper open” and “dashboard damper open” settings in immediate succession. In addition, the air conditioning system is designed such that specific settings do not overlap, and blended settings are avoided. To decrease the time required to adjust the damper controls to select the “windshield damper open” position, for example when the air conditioning system is started up, this setting is placed in the center region of the adjustment path and thus at the center of the air distribution setting sequence.

This enables the target values for maximum adjustment times for the dampers to be met and allows the time required to adjust the damper controls, in particular to select the “windshield damper open” position, to be reduced. However, the arrangement of the settings is not consistent with that of a traditional control element, for example in the form of a rotary knob, causing irritation for the operator or driver of the motor vehicle.

The object of the invention is to provide a system for air distribution in an air conditioning system of a motor vehicle and a method for operating the system, in which the maximum adjustment time required to reach the “windshield damper open” air distribution setting, for example at the time the system is started up, is minimized. A further object of the invention is to minimize the probability of passing through unexpected and undesired air distribution settings. A further object is to adhere as closely as possible to the known sequence of damper positions and thus the sequence of air distribution settings so as to avoid irritation to the operator.

### SUMMARY OF THE INVENTION

The object is attained by the subject matter and the method having the features of the invention as disclosed herein.

The object is attained by a system according to the invention for air distribution in an air conditioning system of a motor vehicle. The system comprises flow paths with air outlets toward the windshield, in the dashboard, and toward the footwell, and a central gear mechanism having an adjustment element and damper controls for air dampers for opening and closing the air outlets. The adjustment element is designed to be steplessly movable between a first end position and a second end position. By moving the adjustment element, the “windshield damper open”, “footwell damper open” and “dashboard damper open” settings can be selected.

According to the concept of the invention, the central gear mechanism comprising the adjustment element and the damper controls is configured such that the “windshield damper open” setting can be selected at both end positions of the adjustment element.

By configuring the central gear mechanism comprising the adjustment element and the damper controls such that the “windshield damper open” setting can be selected at both end positions of the adjustment element, the time required to adjust the system to the “windshield damper open” setting is decreased substantially, regardless of the initial position or the initial setting of the system. In addition, the traversing of undesired and unexpected air distribution settings is thereby avoided, or the probability of traversing undesired and unexpected air distribution settings is at least decreased, so that fogging of the windshield can be prevented while at the same time ensuring the desired comfort of vehicle passengers. The system according to the invention thus allows a pleasant and comfortable climate to be provided for the vehicle's passengers, while at the same time providing clear visibility through the windshield.

According to an alternative embodiment of the invention, the central gear mechanism comprising the adjustment element and the damper controls is designed such that at least one of the settings “footwell damper open” and “dashboard damper open” can be selected at both of the end positions of the adjustment element.

According to a further enhancement of the invention, the central gear mechanism comprising the adjustment element and the valve controls is designed such that the settings
“only windshield damper open” or
“windshield and footwell dampers open” or
“footwell damper open” or
“all dampers open” or
“dashboard and footwell dampers open” or
“only dashboard damper open” or
“dashboard and windshield dampers open”
   may be selected.

According to a preferred embodiment of the invention, the adjustment element is embodied as a cam disk with integrated cam tracks. Each of the cam tracks has a first end point and a second end point. One damper control is assigned to each cam track. The cam disk is advantageously mounted so as to rotate around a rotational axis between the first end position and the second end position, within an angle range of 0° to a maximum angle, in particular a maximum angle of 288°.

Each of the damper controls is preferably designed as having at least one engagement element, with each engagement element engaging with a cam track of the cam disk and being moved with the rotation of the cam disk.

According to a first alternative embodiment of the invention, a first cam track of the cam disk having the first end point and the second end point, along with the damper control for the air outlets toward the windshield and the engagement element which engages with the cam track is configured such that the “windshield damper open” setting can be selected at both end positions of the cam disk. In this case, the end positions refer to positions of the cam disk in angle ranges of around 0° and between 270° and 288°.

According to a second alternative embodiment of the invention, a second cam track of the cam disk having the first end point and the second end point and having the damper control for the air outlets in the dashboard and the engagement element which engages with the cam track is configured such that the “dashboard damper open” setting can be selected at both of the end positions of the cam disk. In this case, the end positions relate to positions of the cam disk in angle ranges of 0° and 280°.

According to a further enhancement of the invention, the damper controls are embodied as levers and/or gear elements rotatably coupled to one another. In this case, at least one element of each damper control is positioned so as to rotate about a rotational axis in a direction of rotation, such that the dampers connected to the elements of the damper control can be moved so as to open or close the air outlets.

The object is also attained according to the concept of the invention by a method for operating the system according to the invention for air distribution in an air conditioning system of a motor vehicle. The method comprises the following steps in moving the adjustment element between the two end positions:
select “windshield damper open”,
select “windshield and footwell dampers open”,
select “footwell damper open”,
select “all dampers open”,
select “dashboard and footwell dampers open”,
select “dashboard damper open”,
select “dashboard and windshield dampers open”, and
select “windshield damper open”.

According to an advantageous embodiment of the invention, in which the system has an adjustment element embodied as a cam disk with integrated cam tracks, the cam disk is rotated around a rotational axis as it is moved from the first end position to the second end position. In so doing, the cam disk is preferably rotated within an angle range of 0° up to a maximum angle, in particular a maximum angle of 288°.

The “windshield damper open” setting is preferably selected when the cam disk is at an angle of around 0°, and when the cam disk is at an angle in the range of 280° to 288°.

In a further enhancement of the invention, regardless of the initial position of the adjustment element, the adjustment element sweeps through an angle range of one-half the maximum angle, in particular a maximum of approximately 140°, before reaching the “windshield damper open” setting. To sweep through an angle range of 140° at an adjustment rate of 24°/second, the adjustment element is advantageously moved in a maximum adjustment time of approximately 6 seconds.

According to a further preferred embodiment of the invention, regardless of the initial position of the adjustment element, the system passes through either the “footwell damper open” setting or the “dashboard damper open” setting in order to reach the “windshield damper open” setting.

The system according to the invention for air distribution in an air conditioning system of a motor vehicle and the method for operating the system together offer various advantages:
a significant decrease in the adjustment time required to select “windshield damper open” as compared with known prior art systems,
a prevention of or a decrease in the probability of passing through undesired and unexpected air distribution settings, and
an adherence to the sequence of air damper positions, and thus of the sequence and the succession of settings in traditional air distribution systems, with
no additional structural complexity in the configuration of the system.

### BRIEF DESCRIPTION OF THE DRAWINGS

Additional details, features and advantages of embodiments of the invention are provided in the following description of embodiment examples, with reference to the accompanying set of drawings. The drawings show:

FIG. 1: the sequence of positions of the dampers and the air distribution settings based on the damper angle, as a function of the position of a cam disk in a traditional air distribution system which has a maximum adjustment time to reach the “windshield damper open” setting;

FIG. 2: the sequence of positions of the dampers and the air distribution settings based on the damper angle, as a function of the position of a cam disk in the air distribution system which has maximum adjustment times to reach a “windshield damper open” setting; and

FIG. 3: an air distribution system for an air conditioning system of a motor vehicle having a central gear mechanism with a cam disk which has integrated cam tracks and damper controls.

### DESCRIPTION OF SPECIFIC EMBODIMENTS

FIG. 2 shows a graph illustrating the sequence of positions of the dampers and the air distribution settings based on the damper angle, as a function of the position of a cam disk of the air distribution system that has maximum adjustment times to reach the “windshield damper open” setting.

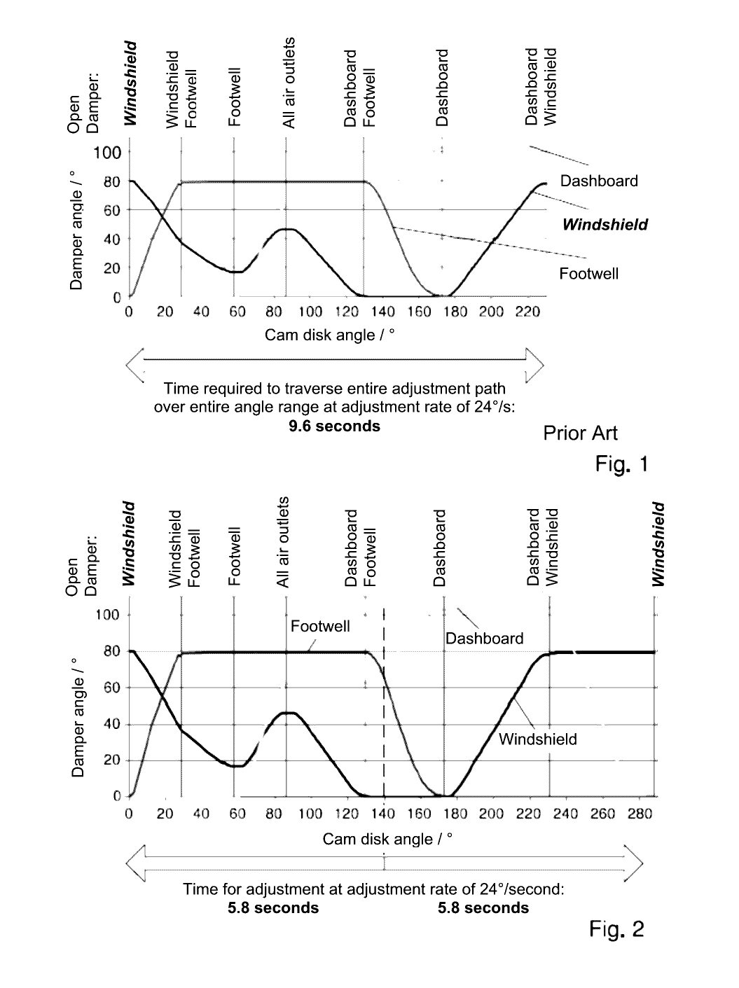

As in FIG. 1, the angles of each of the dampers of the air outlets toward the windshield, in the dashboard and into the footwell are plotted using individual characteristic curves as a function of the angle of the cam disk being adjusted.

As compared with the air distribution setting according to FIG. 1, the cam disk is rotatable within an angle range of 0° to 288°. The expansion of the angle range from 230° to 288° enables the creation of a second “windshield damper open” setting. The flow path to the air outlets toward the windshield is therefore open at a cam disk angle of around 0°, at a cam disk angle of around 230° in a blended setting with the flow path toward the air outlets in the dashboard, and at a cam disk angle in the range of 230° or more.

In addition to the first “windshield damper open” setting at the start of the adjustment path for the cam disk at 0°, a second “windshield damper open” setting is formed at the end of the adjustment path for the cam disk in an angle range beyond 270°, and thus at the other end of the sequence of air damper positions. In this case only the flow path to the air outlets toward the windshield is open, while the flow paths to the other air outlets are largely closed, at least within an angle range for the cam disk of approximately 270° to 288°.

The maximum adjustment time required to reach the “windshield damper open” setting is thereby decreased by about one-half as compared with the traditional arrangement of the air distribution system settings according to FIG. 1, and the probability of passing through unexpected and undesired air distribution settings is decreased.

In the worst case, that is to say, at the “dashboard and footwell dampers open” setting, with the cam disk at an angle of approximately 140°, an angle range of 140°, in other words between 140° and 0° or between 140° and 280°, must be swept through in order to reach one of the “windshield damper open” settings at the beginning or the end of the sequence of positions of the air dampers. Assuming an adjustment rate of 24°/second, an adjustment time of approximately 6 seconds is required to sweep through an angle range of 140°.

In this process, a passing through of other main settings of the air distribution system is not avoided entirely. However, the system passes through only the main settings “footwell damper open” or “dashboard damper open”. Starting the rotation of the cam disk at an angle of 140°, and the resulting sequence of air damper positions and air distribution settings also results in less irritation and fewer changes to the air distribution settings, since the initial cam disk angle setting of 140° already has fractions of the air flow mass passing through the relevant footwell and dashboard air outlets.

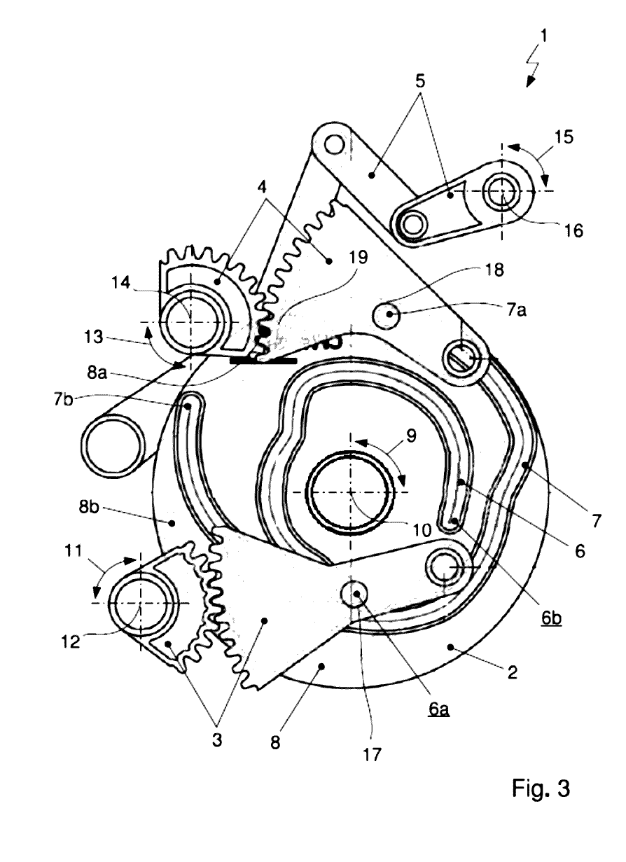

FIG. 3 shows a system 1 for air distribution in an air conditioning system of a motor vehicle, which is embodied as a central gear mechanism having a cam disk 2 with integrated cam tracks 6, 7, 8 and damper controls 3, 4, 5 for various air outlets into the passenger compartment.

The air flow mass that is conditioned as it flows through the air conditioning system can be divided, for example, among three different flow paths proceeding from a blending chamber. At the ends of the flow paths that are distant from the blending chamber are air outlets that can be closed off by dampers. The air is conducted through the air outlets toward the windshield, out of the dashboard toward the vehicle passengers, and into the footwell.

The dampers of the air outlets are interconnected and can be adjusted together via the central gear mechanism or the central drive having the adjustment element embodied as cam disk 2 and damper controls 3, 4, 5. The damper controls 3, 4, 5 are embodied as levers and/or gear elements that are rotatably coupled to one another.

The cam disk 2 can be rotated by the driver of the motor vehicle in a direction of rotation 9 around a rotational axis 10, for example via a control element embodied as a rotary knob. The control element, not shown, has a transmitting element, for example a Bowden cable, for transmitting the rotational movement of the control element to the cam disk 2.

The control element can be adjusted within an angle range of 0° to 288° and can be equipped with symbols for the air distribution settings, in particular the opened air outlets for the windshield, the dashboard and the footwell. When the control element is set to the respective symbols, the air outlets associated with those symbols are opened. When the control element is positioned in the areas between the symbols, the air dampers are adjusted to intermediate positions.

According to FIG. 2, when the control element, and thus the cam disk 2, is located in the region around 0°, only the air outlets toward the windshield are opened. When the control element is rotated further, the flow cross-sections of the air outlets toward the windshield are decreased, while the air outlets toward the footwell are opened, so that when the cam disk 2 is at an angle of around 20°, the air outlets toward the windshield and toward the footwell are opened in a blended setting. The air outlets to the footwell are opened to their maximum at an angle of approximately 130°. The flow cross-sections of the air outlets to the footwell are decreased constantly as the cam disk 2 is adjusted between 130° and 170°, and are closed beyond an angle of the cam disk 2 of 170°. At the same time, the air outlets in the dashboard are opened within an angle range of between 60° and 170°, beginning at approximately 70°, and are opened to their maximum in an angle range of 170° to 230°. Beyond a cam disk angle of 230° the flow cross-sections of the air outlets in the dashboard begin to decrease, and they are closed off beyond an angle of approximately 280°.

When the cam disk 2 is adjusted to the range of 60° to 90°, the air outlets toward the windshield begin to open wider again, so that at an angle of approximately 90° all air outlets are open. Beyond an angle of the cam disk 2 of 90°, the flow cross-sections of the air outlets toward the windshield are decreased. Within the range of 120° to 180°, the air outlets toward the windshield are closed off, and as the angle increases beyond 180°, they are opened constantly. Thus, in an angle range of approximately 130°, only the air outlets in the dashboard and toward the footwell are opened, in a blended setting. In an angle range of 230° to 288°, the air outlets toward the windshield are completely open. In the range around 230°, the air outlets in the dashboard and toward the windshield are opened in a blended setting, whereas with further rotation of the cam disk 2, the flow cross-sections of the air outlets in the dashboard are decreased, and beyond an angle of approximately 270°, only the air outlets toward the windshield are open.

Thus, the air outlets toward the windshield are the only air outlets in the air conditioning system that are open into the passenger compartment when the cam disk 2 is at an angle of around 0° and at an angle greater than 270°. The flow cross-section of the air outlets toward the windshield has the maximum value.

The central gear mechanism is embodied such that the dampers of the various air outlets can be opened and closed in both the clockwise and the counterclockwise directions, and such that air outlets remain opened and/or closed while other air outlets are being opened and/or closed.

The cam disk 2 is embodied as a connecting element for interconnecting the damper controls 3, 4, 5 of the various air outlets, and also as an adjustment element for moving the damper controls 3, 4, 5, and thus the dampers of the air outlets, together. The damper controls 3, 4, 5 are embodied as having engagement elements 17, 18, 19, each of which engages with one of the cam tracks 6, 7, 8 of the cam disk 2.

By rotating the cam disk 2, the positions of the engagement element 17 of damper control 3 for the air outlets of the footwell within the cam track 6, of the engagement element 18 of the damper control 4 for the air outlets in the dashboard within the cam track 7, and of the engagement element 18 of the damper control 5 for the air outlets toward the windshield within the cam track 8 are changed relative to one another. FIG. 3 shows an end position of the cam disk 2, in which each of the engagement elements 17, 18, 19 of the damper controls 3, 4, 5 is situated at the end of a respective one of the cam tracks 6, 7, 8.

By rotating the cam disk 2 in the direction of rotation 9 around the rotational axis 10, and thereby changing the positions of the engagement elements 17, 18, 19 within the cam tracks 6, 7, 8, the damper controls 3, 4, 5 are moved, and the air outlets are closed or opened according to the sequence specified above. In this process, one element of each of the damper controls 3, 4, 5 is rotated in a direction of rotation 11, 13, 15 around a rotational axis 12, 14, 16, which in turn effects a rotation and a change in the position of the dampers of the air outlets.

The cam tracks 6, 7, 8 of the cam disk 2 each have a first end point 6a, 7a, 8a and a second end point 6b, 7b, 8b.

The cam track 8 of the damper control 5 for the air outlets toward the windshield is configured in the region of the second end point 8b such that when the cam disk 2 is rotated within an angle range of 230° to 288°, resulting in a relative movement of the engagement element 19 within the cam track 8, the damper control 5 is not moved, or is moved in such a way that the air dampers of the air outlets toward the windshield remain in a constant open setting, in particular within a damper angle of around 80°. Thus, when the cam disk 2 is in the end position, in an angle range of 270° to 288°, the “windshield damper open” setting is achieved and maintained.

The cam track 7 of the damper control 4 for the air outlets in the dashboard is configured in the region of second end point 8b in such a way that when the cam disk 2 is rotated within an angle range of 230° to 288°, resulting in a relative movement of the engagement element 18 within the cam track 7, the damper control 4 is moved in such a way that the flow cross-sections of the air outlets in the dashboard are decreased constantly, or the air outlets are closed.

The configuration of the cam disk 2, particularly the configuration of the second end points 7b, 8b of the cam tracks 7, 8 and the configuration of the damper controls 4, 5 for the air outlets in the dashboard and toward the windshield, enables the first “windshield damper open” setting, but also the second “windshield damper open” setting, and enables the air dampers for the air outlets in the dashboard and toward the footwell to remain closed in either case. The “windshield damper open” settings, in which only the air outlets toward the windshield are opened, are reached at the respective ends of the potential angular adjustment range for the cam disk 2.

### LIST OF REFERENCE SIGNS

1 air distribution system
2 cam disk
3 footwell damper control
4 dashboard damper control
5 windshield damper control
6 cam track for footwell damper control 3
6a first end point of cam track 6 for footwell damper control 3
6b second end point of cam track 6 for footwell damper control 3
7 cam track for dashboard damper control 4
7a first end point of cam track 7 for dashboard damper control 4
7b second end point of cam track 7 for dashboard damper control 4
8 cam track for windshield damper control 5
8a first end point of cam track 8 for windshield damper control 5
8b second end point of cam track 8 for windshield damper control 5
9 direction of rotation of cam disk 2
10 rotational axis of cam disk 2
11 direction of rotation of footwell damper control 3
12 rotational axis of footwell damper control 3
13 direction of rotation of dashboard damper control 4
14 rotational axis of dashboard damper control 4
15 direction of rotation of windshield damper control 5
16 rotational axis of windshield damper control 5
17 engagement element of footwell damper control 3
18 engagement element of dashboard damper control 4
19 engagement element of windshield damper control 5

What is claimed is:

1. A system for air distribution in an air conditioning system of a motor vehicle, the system comprising
flow paths with air outlets toward a windshield, in a dashboard, and toward a footwell;
a central gear mechanism having an adjustment element and damper controls for dampers for opening and closing the air outlets, wherein the adjustment element is steplessly movable between a first end position and a second end position, wherein settings “windshield damper open”, “footwell damper open”, and “dashboard damper open” may be selected, and wherein the central gear mechanism is configured such that the “windshield damper open” setting may be selected at both of the first end position and the second end position of the adjustment element.

2. The system according to claim 1, wherein the central gear mechanism is configured such that the settings
“only windshield damper open” or
“windshield and footwell dampers open” or
“footwell damper open” or
“all dampers open” or
“dashboard and footwell dampers open” or
“only dashboard damper open” or
“dashboard and windshield dampers open”
may be selected.

3. The system according to claim 1, wherein the adjustment element is a cam disk with a plurality of integrated cam tracks, each of the cam tracks having a first end point and a second end point, wherein a damper control is assigned to each of the cam tracks.

4. The system according to claim 3, wherein the cam disk is rotatable around a rotational axis between the first end position and the second end position of the adjustment element.

5. The system according to claim 4, wherein the damper control of each of the cam tracks includes at least one engagement element engaging one of the cam tracks of the cam disk and moves with rotation of the cam disk.

6. The system according to any of claim 3, wherein the damper control of each of the cam tracks is a lever or a gear element rotatably coupled to one another, and wherein at least one gear element of the damper control of each of the cam tracks is rotatable in a direction of rotation around a rotational axis in such a way that the dampers are moved to open or close the air outlets.

7. A method for operating a system the method comprising the steps of:
providing a central gear mechanism having an adjustment element and damper controls for dampers for opening and closing air outlets, wherein the adjustment element is steplessly movable between a first end position and a second end position, wherein settings may be selected in movement of the adjustment element between the two end positions:
“windshield damper open”,
“windshield and footwell dampers open”,
“footwell damper open”,
“all dampers open”,
“dashboard and footwell dampers open”,
“dashboard damper open”,
“dashboard and windshield dampers open”, and
“windshield damper open”.

8. The method according to claim 7, wherein the adjustment element is a cam disk with integrated cam tracks, wherein the cam disk is rotated around a rotational axis when moved from the first end position to the second end position.

9. The method according to claim 8, wherein the cam disk is rotated within an angle range of about 0° to 288° when moved from the first end position to the second end position.

10. The method according to claim 9, wherein regardless of an initial position of the cam disk, the cam disk passes through an angle range of about 140°, before reaching the “windshield damper open” setting.

11. The method according to claim 10, wherein regardless of the initial position of the cam disk, the cam disk passes through the “footwell damper open” setting or the “dashboard damper open” setting before reaching the “windshield damper open” setting.
